(19) United States
(12) Patent Application Publication
(10) Pub. No.: US 2007/0295867 A1
(43) Pub. Date: Dec. 27, 2007

(54) CONDUIT SUPPORT APPARATUS

(76) Inventor: John HENNON, Wall Township, NJ (US)

Correspondence Address: DAVIS & BUJOLD, P.L.L.C., 112 PLEASANT STREET, CONCORD, NH, 03301, US

(21) Appl. No.: 11/765,602

(22) Filed: Jun. 20, 2007

Related U.S. Application Data
(60) Provisional application No. 60/815,609, filed on Jun. 21, 2006.

(51) Int. Cl. F16L 3/10

(52) U.S. Cl. 248/74.4

(57) ABSTRACT

A pipe and tube fixed support is provided including a housing consisting of an upper and lower housing with an offset hinge on one side and an offset opening on an opposing side. The offset feature of the support is defined by a coupling plane which is angled relative to a vertical and horizontal axis further defined about a mounting point on the support.

### FIELD OF THE INVENTION

The present invention relates to a pipe and tube support for supporting tubes and pipes along a conduit run. In particular the support includes a top housing and a bottom housing joined together and rotating relative to one another about an offset hinge. The top and bottom housings are provided with liners for cradling various pipes, tubing and conduits primarily within sanitary environments.

### BACKGROUND OF THE INVENTION

Pipe and tube supports are well known for their use in supporting piping systems in residential and commercial buildings as well as throughout numerous industrial manufacturing facilities, for example, food, dairy, beverage, chemical, personal care, bioprocessing, and pharmaceutical manufacturing industries. With respect to industrial facilities, especially those in which particularly clean rooms, sanitary and sterile environments are critical to the manufacturing process, the known pipe supports are configured in a way that does not allow for ease of cleaning nor for shedding dirt, dust and other contaminants which can collect on relatively flat surfaces. Furthermore, even those that are designed with rounded and sloped configurations are intended only for mounting from a ceiling and cannot be mounted on a wall or even the floor without exposing a flat surface to the collection of such dirt, dust or other contaminants.

U.S. Pat. No. 4,784,363 to Brown et al. discloses a radial pipe mount comprised of an upper and lower housing with a fixed mounting point on the upper half that can be welded to a stanchion of beam. The upper and lower housings have horizontally extending tabs on either side of the housings for affixing the two halves together. In addition, the mount includes a sound deadening rubber bushing. As can be appreciated, Brown '363 presents to the environment flat surfaces on the extending tabs, which in most any mounted position, i.e., floor, ceiling or wall, present substantial horizontal surface area for accumulating dirt, debris and contaminants.

U.S. Pat. No. 6,799,607 B1 to Friedline et al. discloses a sanitary conduit support system and methods, which discloses a convex shaped, umbrella type, top housing with a bottom housing having a flat base portion aligned below and not extending laterally beyond the convex, umbrella type, top housing. Although Friedline et al. '607 includes an embodiment of the device which is mounted, via a floor or base support, the device still presents a flat portion which can collect debris and contaminants if rotated 180 degrees.

U.S. Patent Application No. 2005/0205722 A1 to Krueger discloses a pipe and tube support including a pipe and tube support that claims a swivel style mounting point along a vertical axis with an opening having a single bolt capture and opposing hinge placed at a 90° angle off of the vertical axis. Krueger '722 support also has an upper and lower dome-shaped, housing sections with internal liners for holding the pipe. Similar to the other known devices, Krueger '722 also discloses a flat horizontally aligned surface for seating and attachment of the connecting bolt which, if turned upside down, would be a collection surface for debris and contaminants.

### SUMMARY OF THE INVENTION

An object of the present invention is to fabricate a pipe and tube support which is configured so as to shed via gravity fluid, debris, etc., which tend to accumulate on any horizontal surfaces of the support.

Another object of the present invention is to simplify the maintenance and cleaning of the hanger support by utilizing a single, acorn head bolt which holds the top and bottom housings at one side while the opposite side is joined with a shear pin at a hinge.

A still further object of the invention is to define an offset coupling plane along which the top and bottom housings are coupled and provide the offset coupling plane of the top and bottom housings at an angle relative to a vertical and horizontal axis.

A yet still further object of the invention is to provide a pipe support which can be directly attached to a ceiling mount, wall mount or floor mount and not present any horizontal surfaces for collection of dirt, dust, debris or contaminants. In one embodiment, the pipe support is divided at about a 20° angle above and below the x-axis respectively, with the pinned hinge located below the x-axis and the bolt portion above the x-axis. The bolt side is positioned at a 90° angle relative to the plane that divides the two housings allowing maintenance operators greater access to the head of the bolt as well as allowing the bottom housing to swing away for access to the upper housing as well as the hinge.

Another object of the present invention is increased safety by allowing the loose pipe or tube to be supported when the bolt is removed from the top housing further allowing the bottom housing to swing away while cradling the pipe or tube. By having the 20° angle, this allows the bottom housing to have a greater surface area under the diameter of the pipe allowing greater support particularly in wall mount configurations.

The present invention provides a pipe and tube fixed support. The support includes a housing consisting of an upper and lower housing with an offset hinge on one side and an offset opening on an opposing side. The offset feature of the support is defined by a coupling plane which is angled, relative to a vertical and horizontal axis, further defined about a mounting point on the support. In a typical vertical ceiling hung configuration with the vertical axis passing through the mounting point, the coupling plane is angled at about a 20° angle above and below the x-axis respectively, with the pinned hinge located below the x-axis and the bolt portion above the x-axis. Additionally, the connecting bolt, which connects the top and bottom housing, passes through the coupling plane at a 90° angle to permit both greater access to the head of the bolt as well as ensuring that no flat surfaces are present in a horizontal manner no matter what configuration the housing is mounted.

A rounded acorn-type, threaded fastener passes through a hole in the bottom housing and engages a threaded bore in the top housing and tightens the housing around a pipe or tube permitting easy access for cleaning and maintenance. A hinge connecting the top and bottom is located 1800 opposite the fastner and permits opening of the housing with only the actuation of the single fastener. The liner consists of an upper and lower portion mounted to the clamp at the fastener with an alignment pin and recessed channel or ridge support around the inner circumference of the clamp. The liner is made of a plastic material to prevent wear or corrosion around the pipe allowing the pipe to expand and contract as well as accommodate a desired pitch or sloped pipe through the support as needed.

The present invention also relates to a pipe supporting apparatus comprising an upper housing and a lower housing defining a pipe passage therebetween, a mounting part connected to one of the upper and lower housing for mounting the pipe supporting apparatus to a fixture, a hinge connecting a first end portion of the upper housing to a respective first end portion of the lower housing about a hinge axis, a coupling member for coupling a second end portion of the upper housing to a second end portion of the lower housing at an engagement point, and wherein at least one of the hinge axis and the engagement point are circumferentially spaced greater than ninety degrees from the mounting part.

The present invention also relates to a hanger for supporting a conduit, the hanger comprising an upper housing defining an upper conduit engaging area, a lower housing defining a lower conduit engaging area, a mounting device defining a support axis positioned off-center along a circumferential length of the upper housing for supporting the hanger relative to a supporting structure wherein a linear split between the upper housing and the lower housing is non-perpendicular aligned relative to the support axis.

### BRIEF DESCRIPTION OF THE DRAWINGS

FIG. 1 is a front elevational view of the pipe and tube support clamp assembly with liner of the present invention;

FIG. 2 is a cross-sectional view of the pipe and tube support clamp assembly of the present invention;

FIG. 3 is a perspective view of the top of the upper housing of the present invention;

FIG. 4 is a perspective bottom view of the upper housing and upper liner;

FIG. 5 is a perspective top view into the lower housing generally and the lower liner of the present invention;

FIG. 6 is a front elevational view of the pipe and tube support in a wall mount configuration;

FIG. 7 is a front elevational view of the pipe and tube support in a floor mount configuration;

FIG. 8 is a cross-sectional view of the pipe and tube support of a second embodiment having a stepped bolt receiving bore for captively retaining the bolt securing the upper and lower housings together; and

FIGS. 9A, 9B are a side elevational view and top plan view respectively of the securing bolt for the pipe and tube support of this second embodiment.

### DETAILED DESCRIPTION OF THE INVENTION

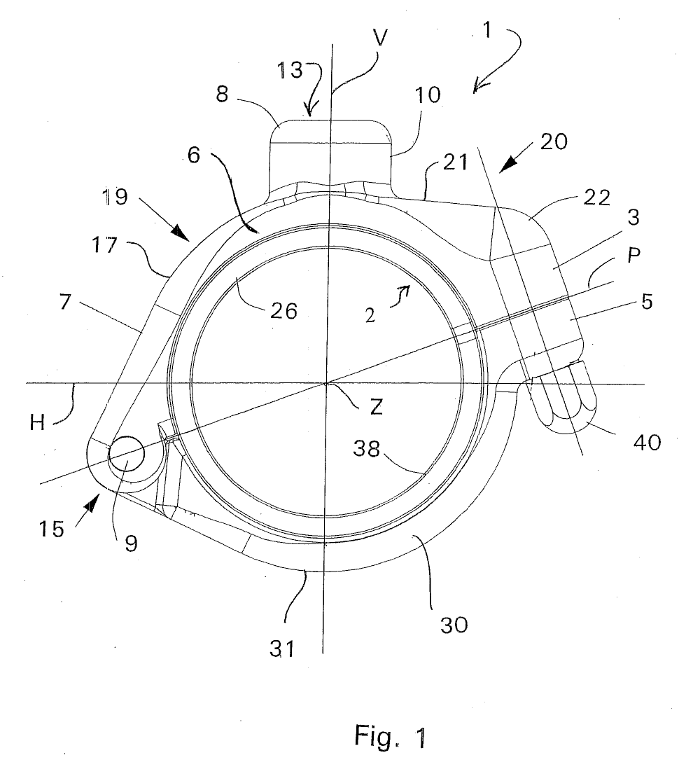

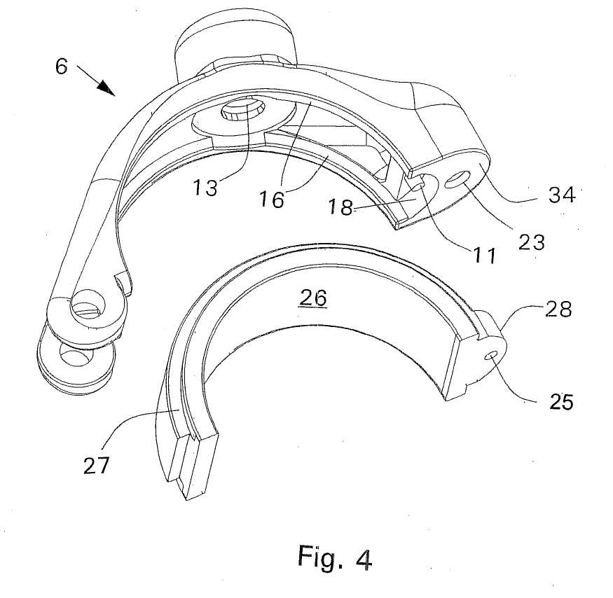

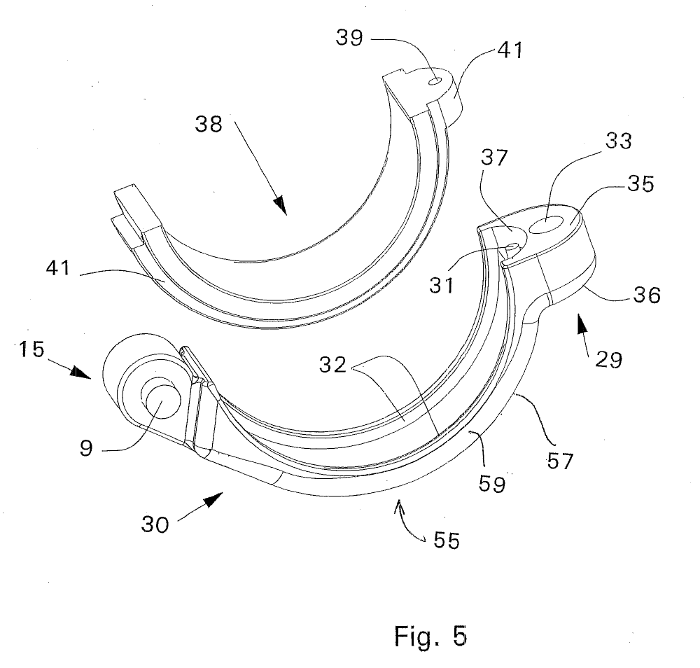

In general, the present invention relates to a pipe and tube support 1 as shown in FIG. 1. The support 1 consists of both an upper housing 6 and lower housing 30 defining a pipe passage therethrough. The upper and lower housings 6, 30 are connected on one side via a hinge 15, and on an opposing side, the upper housing 6 and the lower housing 30 are provided with an upper jaw 3 and a lower jaw 5 demountably coupled via a threaded, acorn-style bolt 40. The support 1 further includes an inner liner 2 substantially circumferentially encompassing the pipe passage. The liner 2 consists of an upper liner 26 and a lower liner 38 demountably affixed in the respective upper and lower housings 6, 30. As best seen in FIGS. 4 and 5 and discussed in further detail below, the upper and lower liners 26, 38 may be demountably affixed to the respective upper and lower housings 6, 30 through the use of integral alignment pins 11, 31 located on both the upper housing 6 and the lower housing 30. Recessed channels 16, 32 formed in both the upper housing 6 and lower housing 30 prevent any lateral movement of the plastic liner thereby providing a solid, but relatively flexible clamping surface for the pipe or tube.

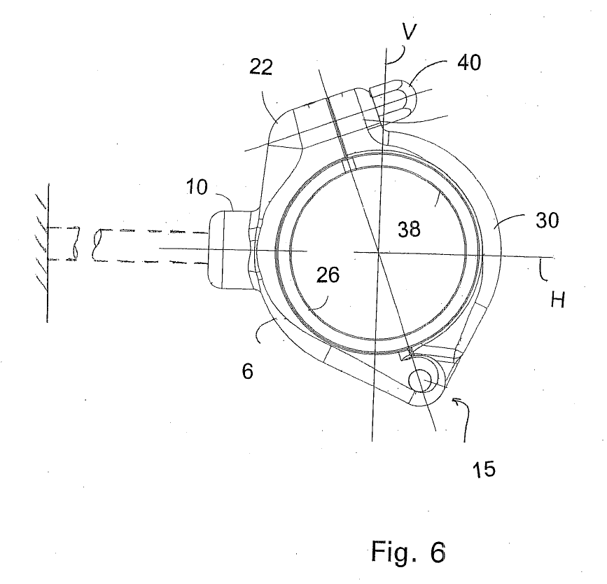

Integral with the upper housing 6 is a mounting point 10 defining a mounting passage 13 for engaging with supporting mounting fixtures, for example, a rod (not shown) generally extending either from a ceiling, wall or floor of a facility. Importantly, the support 1 is capable of being mounted in any of these ceiling, wall or floor configurations without presenting any horizontal surfaces to the environment nor needing any modification of the support 1. By horizontal is meant horizontal or perpendicular relative to the general vertical direction defined by the pull of gravity. For example, in the ceiling mounted configuration, the mounting passage 13 is aligned about a vertical axis V, which depends from the ceiling generally in a vertical direction coinciding with gravitational pull. In the wall mounted configuration the mounting passage 13 is aligned about a horizontal axis H, as best seen in FIG. 6 and discussed in further detail below. For purposes of the following description and clarity, the support 1 shown in FIG. 1 is deemed to be in a vertical ceiling supported configuration having the vertical axis V disposed through the mounting passage 13.

The upper housing 6 consists of a first shoulder 19 and a second shoulder 20 on either side of the mounting point 10. The first shoulder 19 extends from the mounting point 10, generally in a downward convexly curved manner, to a substantially laterally outwardly sloped portion 7′ leading to the hinge portion 15. The first shoulder 19 is defined by a top surface 17 which, while curving convexly downward about the Z-axis extending into and out of the page, is generally flat or parallel to the Z-axis. The second shoulder 20 has a slightly sloped top surface 21 leading to a relatively rounded spur 22 having a laterally outwardly sloped profile.

This rounded spur 22 on the second shoulder 20 defines an internal threaded cavity 23 that accepts an acorn-style, threaded bolt 40 for securing the upper housing 6 to the lower housing 30 as discussed below. The rounded spur 22 also forms the upper jaw 3 and an upper front mating surface 34 for mating with the lower jaw 5 of the lower housing 30 as described in further detail below.

The lower housing 30 curves contiguously about the Z-axis to define the lower half of the support 1 and the pipe passage from a hinge point 9 connection with the upper housing 6 to the lower jaw 5, which includes a throughbore passage 33 for receiving the threaded bolt 40 therethrough. The outer surface 31 of the lower housing 310 may have a slightly varying radius of curvature, but is a continuous uninterrupted curve extending from the hinge 9 to the lower jaw 5. In other words, there is no further fixture or attachment point on the lower housing 30 because the support 1 itself is capable of being supported in any of the ceiling, floor and wall configurations solely by the mounting point 10 on the upper housing 6. The lower jaw 5 of the lower housing 30 includes a generally flat or planar lower mating surface 35 which mates with the corresponding upper front mating surface 34 when the bolt 40 is tightened.

The upper and lower housings 6, 30 of the support 1 separate or split apart from one another about the hinge 9 along a coupling plane P. The coupling plane P is defined as the plane passing through the hinge point 9, the intersection of the vertical, horizontal and Z-axes V-H-Z and the engagement of the upper jaw 3 and the lower jaw 5 of the support 1. As is readily apparent from FIG. 1, in the ceiling mounted configuration, the coupling plane P does not coincide with the horizontal axis H, but is angled or offset relative thereto approximately 20-30 degrees, other angles of offset from the horizontal and vertical axes H, V may be contemplated as well.

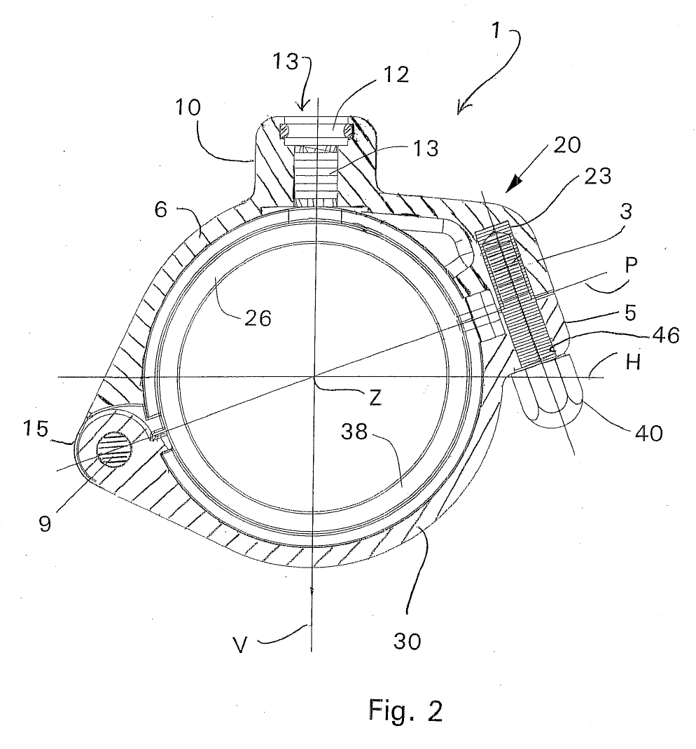

FIG. 2 is a plane cross-section view of the pipe and tube support 1 of the present invention illustrating the internal portions of the upper housing 6 with emphasis on the mounting point 10, mounting passage 13, including an O-ring 12 placement as well as the threaded cavity 23 in the second shoulder 20 where the acorn-style, threaded bolt 40 engages. The view also illustrates the closed position of the lower housing 30 and upper housing 6 with the upper jaw 3 and the lower jaw 5 coupled together, the upper liner 26 and lower liner 38 clamped within the pipe passage, as well as the hinge 15 with the hinge pin 9.

The mounting passage 13 extends through the upper housing 6 along the vertical axis V so that an appropriate mounting fixture (not shown) can be inserted therethrough to uphold the support 1 in any of the desired configurations. It is to be appreciated that the mounting passage 13 may be threaded to threadably engage a cooperatively threaded, mounting fixture or may be smooth to facilitate some relative movement between the fixture and the support 1. For example, a ceiling mounted fixture having a washer affixed thereon may be inserted through the mounting passage 13 so that the washer, which is larger in diameter than the mounting passage, engages within the support slot formed at the bottom of the mounting passage and the support 1 hangs from the fixture along the vertical axis V.

Also formed in the mounting passage 13 is a radial channel for receiving an O-ring 12 therein. The O-ring 12 may be any type of an elastic O-ring 12 as known in the art for sealing and dampening the connection between the fixture and the support 1 while still permitting a desired amount of relative movement between the support 1 and the fixture. The mounting passage 13 may also include a stepped bore in the vicinity of the radial channel to accommodate specifically designed fixtures. Importantly, the mounting point 10 and, coincidentally, the mounting passage 13 are not centered on the upper housing 6, but actually offset in a manner which brings these elements in closer circumferential distance to the end of the upper housing 6 forming the upper jaw 3. This structure leads to the corresponding offset nature of the hinge 15 and the angular nature of the coupling plane P relative to the horizontal and vertical axes V-H.

The upper housing 6, specifically the rounded spur 22, includes the internal threaded cavity 23 for receiving the threaded bolt 40. The bolt 40 passes through either a threaded or an unthreaded throughbore 46 in the lower housing 30 and engages the threaded cavity 23 formed in the upper housing 6 to secure the upper and lower housings 6, 30 together. The bolt 40 passes through the coupling plane P at a right angle so that the threaded cavity 23 and the throughbore 46 are at a corresponding right angle to the coupling plane P and offset or angled relative to the vertical axis V and horizontal axis H.

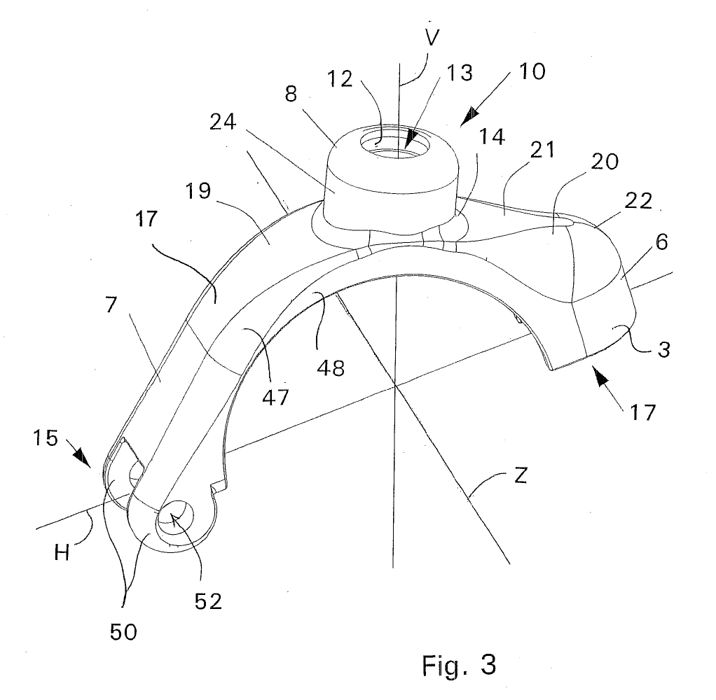

FIG. 3 is a perspective view from above the upper housing 6 and illustrates the complex outer surface geometry of the upper housing 6. This view further illustrates the prominent features of the mounting point 10 as well as the first and second shoulders 19, 20 convexly extending and defined about the Z-axis on either side of the mounting point 10. The first shoulder 19 extends from the mounting point 10 in a downward convexly curved manner about the Z-axis to form the hinge portion 15. The first shoulder 19, while curving convexly downward about the Z-axis, is defined by the top surface 17 which is partially parallel to the Z-axis. Front and rear edges 47 of this top surface 17 contour downwards to form respective front and rear sides 48 of the upper housing 6. In this manner, there are no horizontal planar surfaces upon which dirt, debris, fluids, etc., can rest. Anything which happens to land on the first shoulder 19 will be enticed by the respective curvature of the upper housing 6 and the influence of gravity to slide or fall off the support 1.

The hinge 15 at the extreme end of the first shoulder 19 includes a pair of oppositely disposed flanges 50. Each flange 50 has a collinear hinge pin passage 52 formed therein and the flanges 50 further define a recess therebetween for receiving a respective hinge end of the lower housing 30.

The second shoulder 20 also has a convexly extending top surface profile 21 defined about the Z-axis on the opposing side of the mounting point 10. Although less aggressively curved than the first shoulder 19, the top surface profile 21 of the second shoulder 20 leads convexly downwards from the mounting point 10 about the Z-axis to the rounded spur 22. The spur 22 has a steep laterally outwardly sloped edge, leading finally to meet the respective front and rear sides 48 of the upper housing 6 and form the upper jaw 3. As previously discussed, this rounded spur 22 on the second shoulder 20 defines an internal threaded cavity 23 that accepts an acorn-style, threaded bolt 40 for securing the upper housing 6 to the lower housing 30 as discussed in further detail below.

The mounting point 10 has a domed, upper surface 8 curving downwards from an entrance to the mounting passage 13 to form the cylindrical sidewall 24 of the mounting point 10. The sidewall 24 of the mounting point 10 is integral with the upper housing 6 and is also blended at the base of the sidewall 24 where it meets the upper housing 6 with a fillet 14 to further eliminate any edges, corners or intersections where dust, dirt or other contaminants can accumulate.

In FIG. 4 is a perspective view of the upper housing 6 and upper liner 26 looking from the under side. This view illustrates the upper housing 6 and the mounting passage 13 and the threaded cavity 23 as well as the alignment pin 11 that protrudes from the cutout 18 where the inner liner 2 attaches thereto. The underside of the upper housing 6 is formed so as to readily accept and retain the upper liner 26 for directly cradling the pipe to be supported. The underside of the upper housing 6 includes a stepped recessed channel 16 extending substantially entirely around the underside circumference of the upper housing 6. In addition, the arc-shaped cutout 18 is provided in the underside of the upper housing 6 adjacent a first end of the recessed channel 16. The cutout 18, which could be other shapes besides merely arced, can contain the alignment pin 11 to facilitate the retention of the plastic liner 26.

The channel 16 accepts the upper liner 26 which includes on a front portion thereof a matching lip 28 having an alignment hole 25 to be frictionally engaged with the lip channel 18 and the alignment pin 11. The upper liner 26 further includes liner side edges 27 which are inversely stepped relative to the recessed channel 16 so as to fit snugly therein and permit relatively easy insertion and removal of the liner from the upper housing 6 while providing sufficient engagement therein so as to not be removed with some application of force by a user.

Turning now to the lower housing 30 as shown in further detail in FIG. 5, the lower housing 30 has the hinge end which connects to the opposing flanges 50 of the upper housing 6 by the hinge pin 9 at the location of the hinge 15. The lower housing 30 curves convexly about the Z-axis and the outer surface 55 is a generally a planar surface parallel to the Z-axis with rounded edges 57 depending to the front and rear sides 59 of the lower housing 30. The housing 30 further includes the throughbore passage 33 formed through the lower jaw 5 for receiving the threaded bolt 40. There is a flat surface defining the lower mating surface 35 for the acorn-style, threaded bolt 40 to tighten against the upper mating surface 34 of the upper jaw 3. When coupled together, the upper and lower mating surfaces 34, 35 define the coupling plane P about which the support 1 opens. A second bolt head surface 29 is provided the lower jaw 5 and the acorn-style, thread bolt 40 pulls on and is tightened against the bolt head surface 29 when the upper and lower housings 6, 30 of the support 1 are coupled to one another.

The lower housing 30 also includes the stepped recessed channel 32 leading to the alignment pin 31 that is surrounded by an alignment lip channel 37 and is opposing the hinge 15. The channel 32 accepts the lower liner 38 which has an opposing alignment hole 39 which is surrounded by an alignment lip 411. The alignment hole 39 and lip 41 slide into the alignment lip channel 37 and on top of the alignment pin 311. A stepped edge 40 is used on the lower liner 38 which mates to the recessed channel 32 on the lower housing 30.

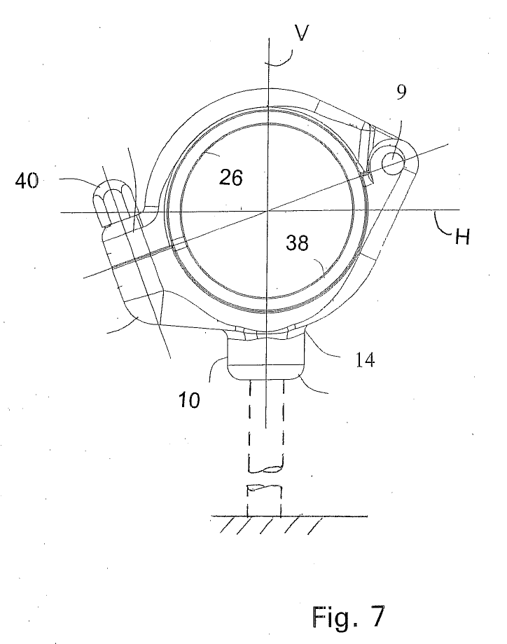

The importance of the above described geometry and structure of the support 1 is that the support 1 can be used in a ceiling, wall or floor supported configuration. For example, the support 1 can be vertically suspended and hung from a ceiling as is typically conventional, i.e., right side up as in FIGS. 1 and 2. The support 1 can also be horizontally supported by a wall and hence in a sideways manner as depicted in FIG. 6 for supporting a horizontally extending pipe. Also with such a wall support the support 1 itself can be rotated about the horizontal axis H to a substantially horizontal position to accommodate a vertically aligned pipe. Importantly, the support can also be used in an upside down manner as in FIG. 7, without presenting any horizontal planar surfaces for collecting dirt, debris, fluids or contaminants. In certain industrial applications for clean rooms, rooms are decontaminated by washing down the entire room with decontamination fluids. It is imperative that there be no or few areas, for example, planar horizontal surfaces, where fluid or debris will collect. The present invention ensures that a single pipe support can be used in any of the configurations to satisfy such a requirement without modifying the support itself in any way. Observing FIGS. 6 and 7, FIG. 6 is an example of a wall mount configuration where the coupling plane P is now approximately 20-30° offset from the vertical axis V. As can be readily observed there are no horizontal planar surfaces in this configuration and thus dirt, debris, fluids etc will fall off the support. Similarly, in FIG. 7, which discloses the floor mount configuration, again no horizontal planar surfaces are present. The offset coupling plane P of the support 1 ensures that the flat planar surfaces on the upper and lower jaws 3, 5 are always sloped relative to the horizontal plane or axis H.

The support 1 can be cast from any material such as stainless steel, aluminum, brass or any variation of carbon steel. These various metals will allow the support 1 to be used in a multitude of environments such as medical manufacturing, food process or any form of general manufacturing as well as general habitable environments.

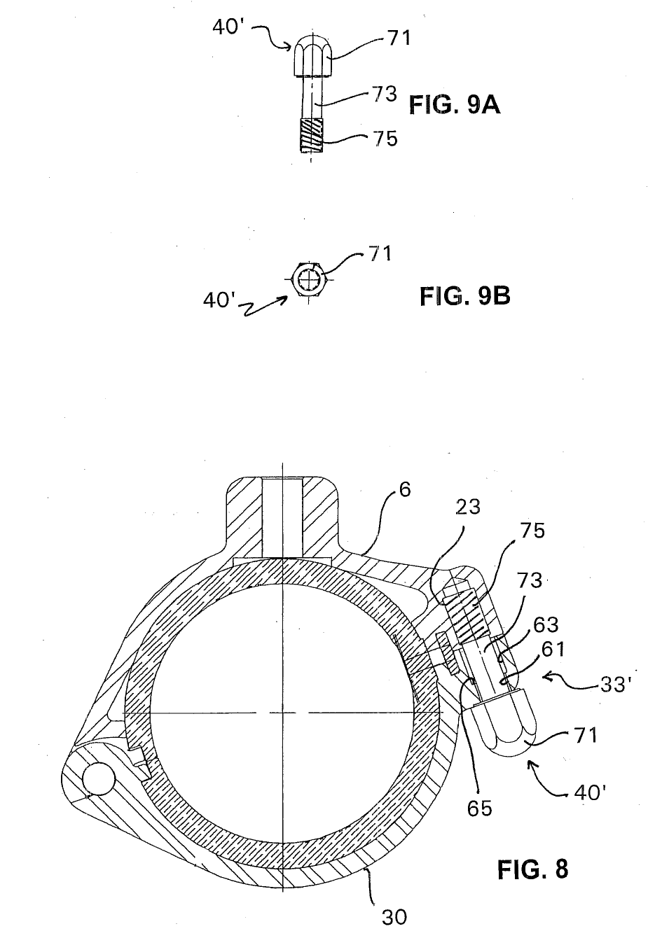

In a further embodiment of the present invention shown in FIGS. 8, 9a and 9b, a unique structure is provided for retaining a modified acorn-style, threaded bolt 40′. As previously discussed, and observing FIG. 8, the lower housing 30 which integrally includes the lower jaw 5 is provided with the through bore passage 33, which, in this embodiment comprises a stepped bore 33′. The stepped bore 33′ is defined by two distinct portions, a bore neck 61 and a main bore 63 each having different diameters. The bore neck 61 has a smaller diameter than the main bore 63 and extends from the bolt head surface 29 a desired distance through the lower jaw 5 until is meets the main bore 63 which has a larger diameter than the bore neck 61. Additionally, the bore neck 61 is threaded so that the acorn-style threaded bolt 40′ can be threaded through the bore neck 61 and be retained by the stepped bore 33′ in a manner as explained below in further detail.

The main bore 63 extends from an intersection with the bore neck 61 to the lower mating surface 35 of the lower jaw 5. The intersection of the bore neck 61 and main bore 63 defines a step or ledge 65 at a desired point along the length of the stepped bore 33′. Such a stepped bore 33′ will assist in actively retaining the acorn-style threaded bolt 40 even when the acorn-style threaded bolt 40 is uncoupled and the lower housing 30 is released from engagement with the upper housing 6.

Shown in FIGS. 9A, 9B the acorn-style threaded bolt 40′ of this embodiment which is retained in the stepped bore 33′ described above, includes a bolt head 71, an intermediate stem portion 73 and a threaded end portion 75. The bolt head 71 is of course provided with a greater diameter than the bore neck 61 defining the smaller diameter portion of the stepped bore 33′ so that when the upper and lower housings 6, 30 are tightened together, the bolt head 71 tightens against the second bolt head surface 29 so that the upper and lower housings 6, 30 are secured together with one another. The intermediate stem portion 73 is provided with a diameter slightly smaller than the threaded smaller diameter bore neck 61 to facilitate the passage of the stem portion 73 and a sliding or slight frictional engagement which allows an axial sliding movement of the bolt 40′ relative to the bore neck 61 and hence the lower jaw 5 when the upper and lower housings 6, 30 are unsecured. The threaded end portion 75 of the bolt 40′ is provided with a larger diameter than the intermediate portion 73 and a thread diameter sized for threadably engaging the threaded bore neck 61. The threaded diameter of the end portion 75 also matches the threaded diameter of the receiving bore 23 so as to secure the upper and lower housings 6, 30 together.

The larger threaded diameter of the end portion 75, and the matching threaded diameter of the bore neck 61 in the lower jaw 5 ensures that when it is desired to uncouple the upper and lower housings of the shell, the threaded end portion 75 is released from engagement with the receiving bore 23 in the upper jaw 3 of the upper housing 6, the acorn style threaded bolt 40′ is allowed to slide or “fall” actually relative to the bore neck 61 and the stepped bore 33′ in the lower jaw. As can be appreciated from the above described structure, the threaded end portion 75 which has a matching threaded diameter with that of the bore neck 61 in the stepped bore 33′ is prevented from falling out of the stepped bore 33′ due to the nature of the threaded end portion 75 not being axially passable through the bore neck 61. The acorn-style threaded bolt 40′ would of course have to be rotatably engaged and removed through the threaded bore neck 61, so such a structure ensures that the acorn-style bolt 40′ is captively retained in the stepped bore passage 33′ of the lower jaw 5 so that the bolt 40′ does not fall out or become lost and is always maintained with the lower housing 30 unless the user threadably disengages the bolt 40′ through the bore neck 61.

The bore neck 61 in the through bore passage 33′ is provided with mating threads with a similar thread characteristic to that of the receiving bore 23 in the upper housing 6. This is an important aspect of the present invention as such structure facilitates a user to rotatably insert and engage the acorn style threaded bolt 40′ by rotating it into and through the bore neck 61 until the threaded end portion 75 has completely passed through the bore neck 75. Once the end portion 75 passes completely through the bore neck 61, the intermediate stem portion 73 is generally aligned within the bore neck 75 and the bolt 40′ is thus essentially captively retained by the stepped bore 33′ and is in fact free to have some axial play depending on the length of the intermediate stem portion 73, without inadvertently falling out of the stepped bore 33′.

Another aspect of the present invention relates to the use of an antimicrobial agent in, or applied onto, the liner 2, i.e. the upper liner 26 and the lower liner 38 used in conjunction with the support 1. As explained previously in the specification, the liners 26, 38 are demountably secured in the respective upper and lower housings 6, 30 so as to directly support a desired pipe passing through the support 1. Especially where such supports 1 are utilized in clean rooms, or facilities which must be kept free of contaminants for instance food or drug production facilities, organic and inorganic antimicrobial additives may be incorporated into polyurethane, plastisizers and/or other polymers prior to the extrusion and/or molding process of the liners 2.

Generally a selected antimicrobial solution is added directly into the virgin polymer which is to become the extruded or molded product. It is also possible that such microbial solutions can be applied for instance by spraying or coating onto the completed liner 2 itself and essentially permanently bonded to the surface of the liner 2 and generally never has to be reapplied. In the present invention, this relates directly to the fabrication of the inner liner 2 consisting of the upper liner 216 and the lower liner 38. In clean room applications where the amount of bacteria and contaminants must be strictly controlled the antimicrobial solution which is incorporated into the polymers forming the liner 2 can reduce the amount of bacteria, or any bacteria, which may form at the contact points between pipe support 1 and the pipe itself.

Antimicrobial product protection keeps certain devices, such as food processing equipment, cleaner between cleanings by inhibiting the growth of bacteria that causes stains, odors and product deterioration. Although not a substitute for normal cleaning practices, or specifically designed to protect from any food borne illnesses, the use of such antimicrobial product protection is EPA approved and is NSF listed for use in food zone and splash areas and food surface equipment. More specifically the method includes the steps of at least partially encapsulating a plurality of particles comprising one or more antimicrobial agents and introducing the encapsulated antimicrobial agents into the polyurethane or other polymer used to make the liner 2.

Since certain changes may be made in the above described improved pipe support without departing from the spirit and scope of the invention herein involved, it is intended that all of the subject matter of the above description or shown in the accompanying drawings shall be interpreted merely as examples illustrating the inventive concept herein and shall not be construed as limiting the invention.

I/We claim:

1. A pipe supporting apparatus comprising:
an upper housing and a lower housing defining a pipe passage therebetween;
a mounting part connected to one of the upper and lower housing for mounting the pipe supporting apparatus to a fixture;
a hinge connecting a first end portion of the upper housing to a respective first end portion of the lower housing about a hinge axis;
a coupling member for coupling a second end portion of the upper housing to a second end portion of the lower housing at an engagement point; and
wherein at least one of the hinge axis and the engagement point are circumferentially spaced greater than ninety degrees from the mounting part.

2. The pipe supporting apparatus as set forth in claim 1 wherein the hinge axis is circumferentially spaced greater than ninety degrees from the mounting part and the engagement point is circumferentially spaced less than ninety degrees from the mounting point.

3. The pipe supporting apparatus as set forth in claim 1 wherein the hinge axis is circumferentially spaced less than ninety degrees from the mounting part and the engagement point is circumferentially spaced greater than ninety degrees from the mounting point.

4. The pipe supporting apparatus as set forth in claim 1 further comprising a support axis extending centrally through the mounting part and the support axis is spaced circumferentially closer to one of the first end portion and the second end portion of the upper housing than the respective other of the opposing first and second end portions.

5. The pipe supporting apparatus as set forth in claim 4 wherein a dividing plane between the upper housing and the lower housing is non-perpendicularly oriented relative to the support axis.

6. The pipe supporting apparatus as set forth in claim 5 further comprising an elastomeric liner extending substantially circumferentially about a diameter of the pipe passage, the elastomeric liner having a separation line coinciding with the non-perpendicularly oriented dividing plane between the upper and the lower housing.

7. The pipe supporting apparatus as set forth in claim 4 further comprising a coupling bolt for securing the second end portion of the upper housing to the second end portion of the lower housing along a coupling axis non-parallel aligned with the support axis.

8. The pipe supporting apparatus as set forth in claim 4 further comprising a first configuration of the pipe support apparatus where the support axis depends vertically from a ceiling, a second configuration where the support axis extends horizontally from a wall, and a third configuration where the support axis extends vertically from a floor.

9. The pipe supporting apparatus as set forth in claim 8 wherein when said lower housing is coupled to said upper housing in either the first second or third configuration of the pipe supporting apparatus no portion of the upper or lower housing presents a horizontal planar surface.

10. A hanger for supporting a conduit, the hanger comprising:
an upper housing defining an upper conduit engaging area;
a lower housing defining a lower conduit engaging area;
a mounting device defining a support axis positioned off-center along a circumferential length of the upper housing for supporting the hanger relative to a supporting structure wherein a linear split between the upper housing and the lower housing is non-perpendicular aligned relative to the support axis.

11. A pipe and tube support comprising:
an upper housing demountably connected to a lower housing along an axis of separation non-perpendicularly aligned to a mounting axis connecting the upper housing to a support structure.

12. The pipe and tube support as set forth in claim 11 further comprising a mounting point located on the upper housing defining the mounting axis aligned in one of a horizontal axis and a vertical axis relative to gravitational pull.

13. The pipe and tube support as set forth in claim 12 further comprising a pipe passage defined between the upper housing and the lower housing and a separable liner supported therein.

14. The pipe and tube support as set forth in claim 12 further comprising a connection bolt aligned along a connection axis spaced from both the horizontal and vertical axis for demountably coupling at least one end of the upper housing and the lower housing together.

15. The pipe and tube support as set forth in claim 14 further comprising a hinge axis aligned perpendicular to and intersecting the axis of separation and spaced from the horizontal axis and vertical axis.

16. The pipe and tube support as set forth in claim 11 further comprising a securing bolt being captively retained within a stepped bore of the lower housing for securing the upper and lower housings of the pipe and tube support together.

17. The pipe and tube support as set forth in claim 16 wherein the securing bolt is provided with a bolt head, an intermediate stem portion and a threaded end portion and the intermediate stem portion has a smaller diameter than the bolt head and the threaded end portion.

18. The pipe and tube support as set forth in claim 17 wherein the stepped bore comprises a threaded bore neck and a main bore wherein the threaded bore neck has threads of a mating configuration with the threaded end portion of the securing bolt.

19. The pipe and tube support as set forth in claim 11 wherein the support further comprises a separate liner demountably retained within each of the upper and lower housings and the liner is provided with an antimicrobial agent.
